(19) United States
(12) Patent Application Publication
(10) Pub. No.: US 2019/0331990 A1
(43) Pub. Date: Oct. 31, 2019

(54) PROJECTOR

(71) Applicant: QISDA CORPORATION, Taoyuan City (TW)

(72) Inventors: Jia-Ming Zhang, Taichung City (TW); Ming-Kuen Lin, Taoyuan City (TW)

(21) Appl. No.: 16/372,415

(22) Filed: Apr. 2, 2019

(30) Foreign Application Priority Data
Apr. 28, 2018 (CN) 201810400053.0

(51) Int. Cl. G03B 21/20; G02B 26/00

(52) U.S. Cl. CPC G03B 21/204; G03B 21/208; G02B 26/008; G03B 21/2066

(57) ABSTRACT

A projector includes a light source module, a collimating lens, a dichroic mirror and a wavelength conversion module. The light source module is configured to provide an illumination beam. The collimating lens is configured to collimate the illumination beam. The collimating lens includes a first part and a second part, and an axle positioned between the first part and the second part. The wavelength conversion module is configured to receive the illumination beam from the first part, and further to generate an excitation beam transmitted toward the first part and the second part. The dichroic mirror is disposed on a position corresponding to the first part. The dichroic mirror is configured to reflect the illumination beam toward the first part and be passed by the excitation beam, or further configured to be passed by the illumination beam and reflect the illumination beam.

### BACKGROUND OF THE INVENTION

### 1. Field of the Invention

The present invention relates to a projector, and more particularly, to a laser projector with advantages of fewer components, small dimensions and low assembly cost.

### 2. Description of the Prior Art

The conventional laser projector utilizes the blue light laser source to provide the illumination beam, as disclosed in U.S. Pat. No. 9,618,737. The illumination beam is transformed into an excitation beam with different color via a wavelength conversion device (such as the color wheel partly covered by phosphor powder or quantum dot material); then, the excitation beam can be mixed with the illumination beam for related application. The conventional alignment module utilizes the dichroic component to reflect the illumination beam toward the color wheel. A portion of the color wheel made by wavelength conversion material generates the excitation beam accordingly, and the excitation beam can pass through the dichroic component. Besides, a part of the illumination beam passes through another portion of the color wheel without wavelength conversion function and moves back the dichroic component via reflecting components, and then is reflected by the dichroic component to mix with the excitation beam. The conventional alignment module has drawbacks of expensive hardware cost and heavyweight due to a large number of optical components.

### SUMMARY OF THE INVENTION

The present invention provides a laser projector with advantages of fewer components, small dimensions and low assembly cost for solving above drawbacks.

According to the claimed invention, a projector includes a light source module, a collimating lens, a wavelength conversion module and a dichroic component. The light source module is configured to provide an illumination beam. The collimating lens is configured to receive and transmit the illumination beam. The collimating lens includes a first part and a second part, and an axle positioned between the first part and the second part. The wavelength conversion module is configured to receive the illumination beam through the first part and accordingly generate an excitation beam toward the first part and the second part. The dichroic component is disposed on a position corresponding to the first part. The dichroic component is configured to reflect the illumination beam to the first part and be passed through by the excitation beam, or the dichroic component is configured to be passed through by the illumination beam and reflect the excitation beam.

According to the claimed invention, when the dichroic component is configured to reflect the illumination beam to the first part and be passed through by the excitation beam, the projector further includes a light penetrating component connected to the dichroic component and disposed on a position corresponding to the second part. The illumination beam and the excitation beam pass through the light penetrating component. The illumination beam is blue light, the dichroic component is used to reflect the blue light and be passed by other color light. The excitation beam is yellow light.

According to the claimed invention, when the dichroic component is configured to be passed through by the illumination beam and reflect the excitation beam, the projector further includes a first reflecting component connected to the dichroic component and disposed on a position corresponding to the second part. The first reflecting component is used to reflect the illumination beam and the excitation beam. The illumination beam is blue light, the dichroic component is used to be passed by the blue light and reflect other color light. The excitation beam is yellow light.

The projector of the present invention utilizes the wavelength conversion module capable of reflecting the illumination beam and generating the excitation beam to match with the dichroic component corresponding to the first part of the collimating lens, to form the alignment module having a least amount of elements within constrained space for mixing. The dichroic component may have several applications; for instance, the dichroic component can reflect the illumination beam and allow passing of the excitation beam, or can allow passing of the illumination beam and reflect the excitation beam. Arrangement of the light source module, the dichroic component and the light guiding component of the projector may be changed in accordance with the dichroic component having specific features.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a projector according to an embodiment of the present invention.

FIG. 2 is a diagram of a dichroic component and a light penetrating component according to the embodiment of the present invention.

FIG. 3 is a diagram of a wavelength conversion module according to the embodiment of the present invention.

FIG. 4 is a diagram of the projector according to another embodiment of the present invention.

FIG. 5 is a diagram of the projector according to another embodiment of the present invention.

FIG. 6 is a diagram of the projector according to another embodiment of the present invention.

FIG. 7 is a diagram of showing relation between a light transmittance and a wavelength of the dichroic component according to the embodiment of the present invention.

FIG. 8 is a diagram of showing relation between light transmittance and the wavelength of the dichroic component according to another embodiment of the present invention.

### DETAILED DESCRIPTION

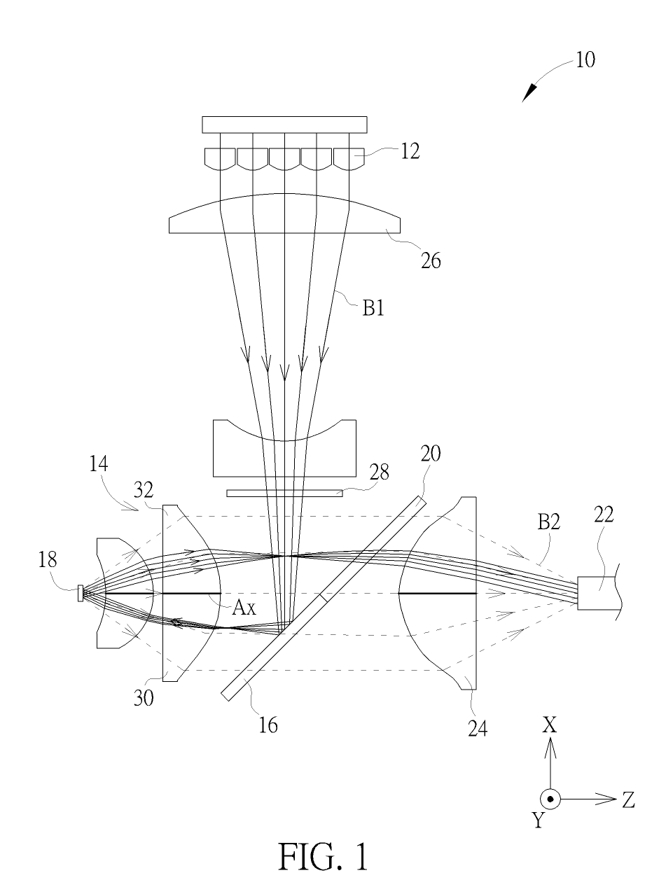

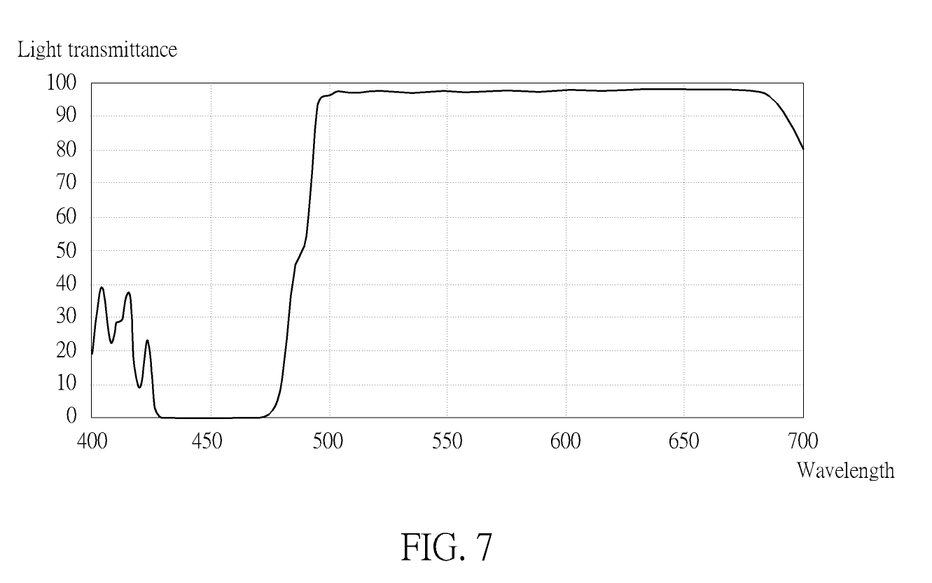

Please refer to FIG. 1 and FIG. 7. FIG. 1 is a diagram of a projector 10 according to an embodiment of the present invention. FIG. 7 is a diagram of showing relation between light transmittance and a wavelength of a dichroic component 16 according to the embodiment of the present invention. An alignment module of the projector 10 can include a light source module 12, a collimating lens 14, a dichroic component 16, a wavelength conversion module 18, a light penetrating component 20, a light guiding component 22, a first condenser lens 24, a second condenser lens 26 and a light diffusing component 28. Some of the above-mentioned components are optional elements, and a detailed description is omitted herein for simplicity. The light source module 12 can emit an illumination beam B1 . The second condenser lens 26 can be disposed on an illumination path of the light source module 12 and used to converge the illumination beam B1 toward the dichroic component 16, which means the second condenser lens 26 can be disposed between the light source module 12 and the dichroic component 16. The light diffusing component 28 preferably can be disposed between the light source module 12 and the dichroic component 16, and used to diffuse the illumination beam B1 for uniform distribution of a spot intensity formed by the illumination beam B1. Position of the light diffusing component 28 is not limited to the above-mentioned embodiment, and depends on design demand.

The dichroic component 16 can be used to reflect the illumination beam B1 toward the collimating lens 14, therefore the light source module 12 and the collimating lens 14 can be both disposed on an upper side or a left side of the dichroic component 16, which means −Z axis of the dichroic component 16, and a position of the light source module 12 relative to the dichroic component 16 is not overlapped with a position of the collimating lens 14 relative to the dichroic component 16. For example, the illumination path of the light source module 12 is not parallel to a receiving path of the collimating lens 14. The collimating lens 14 can include a first part 30 and a second part 32. An axle Ax is set between the first part 30 and the second part 32. The axle Ax can be a central axle or any optical axle of the collimating lens 14, which depends on design demand. A position of the dichroic component 16 corresponds to the first part 30. The dichroic component 16 can reflect the illumination beam B1 toward the first part 30 of the collimating lens 14.

The wavelength conversion module 18 and the dichroic component 16 are respectively disposed on two opposite sides of the collimating lens 14. The illumination beam B1 can pass through the first part 30 of the collimating lens 14 and project onto the wavelength conversion module 18. When receiving the illumination beam B1 from the first part 30, a part of the wavelength conversion module 18 can reflect the illumination beam B1 to the second part 32 and other part of the wavelength conversion module 18 can generate an excitation beam B2 capable of passing through the first part 30 and the second part 32. The illumination beam B1 and the excitation beam B2 passing through the collimating lens 14 can be projected onto the dichroic component 16 and the light penetrating component 20. The light guiding component 22 can be disposed on a lower side or a right side of the dichroic component 16 different from the collimating lens 14 and the wavelength conversion module 18, which means +Z axis of the dichroic component 16, and the first condenser lens 24 can be disposed between the dichroic component 16 and the light guiding component 22. The first condenser lens 24 can be used to converge the illumination beam B1 passing through the second part 32, and the excitation beam B2 passing through the first part 30 and the second part 32. The light guiding component 22 can receive and transfer the illumination beam B1 and the excitation beam B2 from the first condenser lens 24 to other components.

In this embodiment, the light penetrating component 20 can be connected to the dichroic component 16, and a position of the light penetrating component 20 corresponds to the second part 32. The dichroic component 16 can reflect light in a specific wavelength range and be passed through by light not in the specific wavelength range, as an optical property shown in FIG. 7. The light penetrating component 20 can be passed through by light in any wavelength range. For example, when the illumination beam is blue light, the illumination beam B1 (the blue light ranged from 450˜495 nm) can be reflected by the dichroic component 16 toward the wavelength conversion module 18. Some part of the wavelength conversion module 18 can transform the illumination beam B1 into the excitation beam B2 as yellow light. The excitation beam B2 (the yellow light ranged from 570˜590 nm) can pass through the dichroic component 16 and the light penetrating component 20. The illumination beam B1 (the blue light) reflected by the wavelength conversion module 18 can pass through the second part 32 and the light penetrating component 20. The light penetrating component 20 may optionally provide an optical diffusion property used to diffuse the illumination beam B1 and the excitation beam B2 for uniform distribution of an intensity within its spot range.

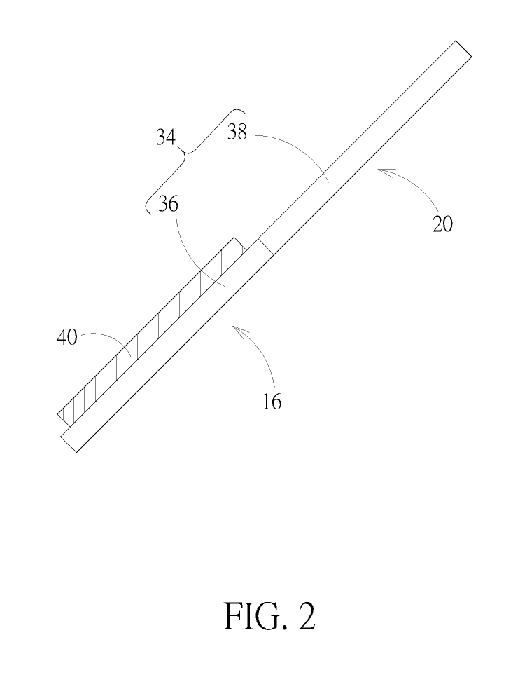

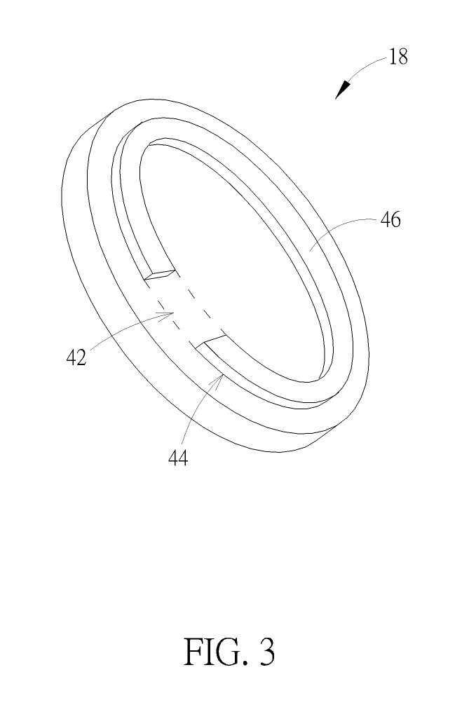

Please refer to FIG. 2 and FIG. 3. FIG. 2 is a diagram of the dichroic component 16 and the light penetrating component 20 according to the embodiment of the present invention. FIG. 3 is a diagram of the wavelength conversion module 18 according to the embodiment of the present invention. As shown in FIG. 2, the projector 10 can includes a transparent substrate 34. The transparent substrate 34 can have a first area 36 and a second area 38, and positions of the first area 36 and the second area 38 respectively correspond to the first part 30 and the second part 32 of the collimating lens 14. The first area 36 can be covered by a coating 40 for forming the dichroic component 16 capable of reflecting light in the specific wavelength range and allowing passing of light not in the specific wavelength range. The second area 38 can be passed through by light in any wavelength range, and can be represented as the light penetrating component 20. The first area 36 and the second area 38 can be integrated with each other, or can be two independent elements assembled with each other. As shown in FIG. 3, the wavelength conversion module 18 can include a first region 42 and a second region 44. The first region 42 can be general reflective material used to reflect the illumination beam B1 from the first part 30 toward the second part 32. The second region 44 can have a wavelength conversion coating 46. The wavelength conversion coating 46 can contain phosphor powder or quantum dot material, and be used to absorb the illumination beam B1 to accordingly generate the excitation beam B2.

In this embodiment, the wavelength conversion module 18 can be a color wheel containing a plate-shaped reflective material, such as the plate made by Aluminum. The second region 44 can be a C-shaped arc range on the plate-shaped reflective material. The first region 42 can be a gap of the C-shaped arc range. When the illumination beam B1 is reflected by the dichroic component 16 to pass through the first part 30 of the collimating lens 14 for projecting onto the wavelength conversion module 18 rotated in a high speed, the first region 42 can directly reflect the illumination beam B1 toward the second part 32 of the collimating lens 14, and the second region 44 can transform the illumination beam B1 into the excitation beam B2 and transmit the excitation beam B2 to the first part 30 and the second part 32 of the collimating lens 14. Therefore, the illumination beam B1 and the excitation beam B2 can be mixed and converged by the first condenser lens 24, and then guided to other components via the light guiding component 22.

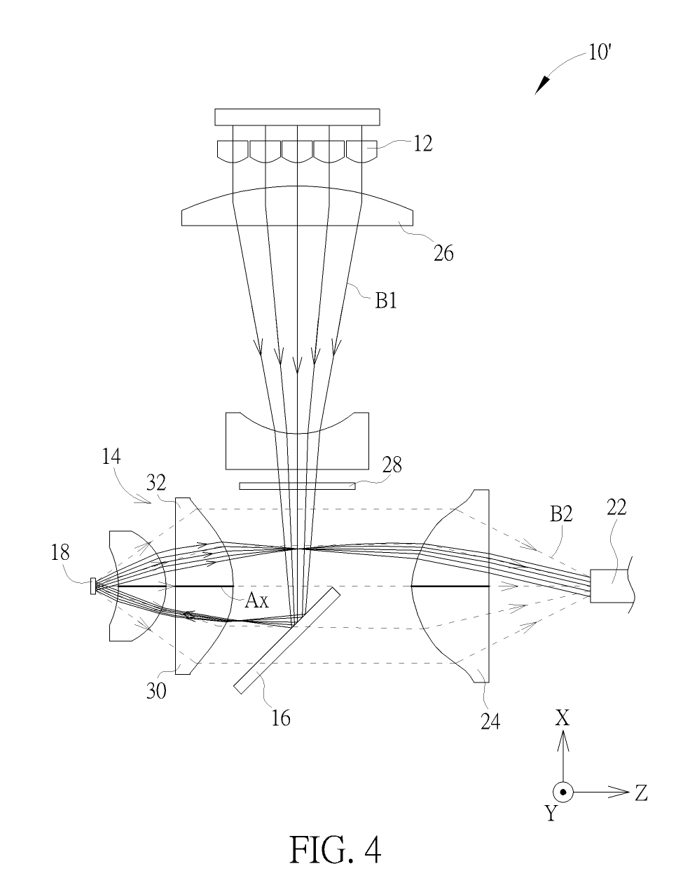

Please refer to FIG. 4. FIG. 4 is a diagram of the projector 10′ according to another embodiment of the present invention. In the embodiment, elements having the same numerals as one of the above-mentioned embodiments have the same structures and functions, and a detailed description is omitted herein for simplicity. Difference between the foresaid embodiments is that the projector 10′ does not dispose the light penetrating component 20 adjacent to the dichroic component 16, which means the projector 10′ disposes the dichroic component 16 between the collimating lens 14 and the first condenser lens 24 and a position of the dichroic component 16 corresponds to the first part 30 of the collimating lens 14. The illumination beam B1 can be reflected by the dichroic component 16 and then pass through the first part 30 of the collimating lens 14 for projecting onto the wavelength conversion module 18. The illumination beam B1 can be reflected by the first region 42 of the wavelength conversion module 18 to sequentially pass through the second part 32 of the collimating lens 14 and the first condenser lens 24. The excitation beam B2 generated by the second region 44 of the wavelength conversion module 18 can sequentially pass through the collimating lens 14 (including the first part 30 and the second part 32) , the dichroic component 16 and the first condenser lens 24, and the illumination beam B1 and the excitation beam B2 can be mixed and converged accordingly.

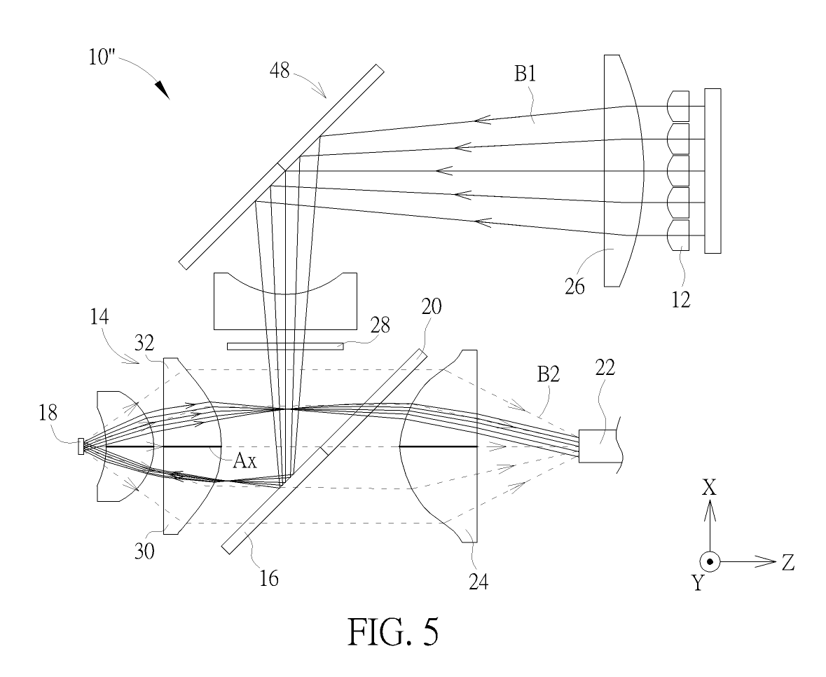

Please refer to FIG. 5. FIG. 5 is a diagram of the projector 10″ according to another embodiment of the present invention. Elements of the projector 10″ are similar to elements of the projector 10. In this embodiment, elements having the same numerals as one of the above-mentioned embodiment have the same structures and functions, and a detailed description is omitted herein for simplicity. Difference between the said two projectors is the light source module 12 of the projector 10″ does not correspond to the dichroic component 16. In this embodiment, the projector 10″ can further include a second reflecting component 48 disposed on the illumination path of the light source module 12 and used to reflect the illumination beam B1 toward the dichroic component 16. Dimensions of the alignment module and the projector 10″ can be minimized by disposition of the second reflecting component 48. It should be mentioned that the position of the second condenser lens 26 is not limited to the embodiment shown in FIG. 5; for example, the second condenser lens 26 can be disposed on the illumination path to converge the illumination beam B1 from the second reflecting component 48 to the dichroic component 16, or can be disposed between the second reflecting component 48 and the dichroic component 16 for converging the illumination beam B1 toward the dichroic component 16.

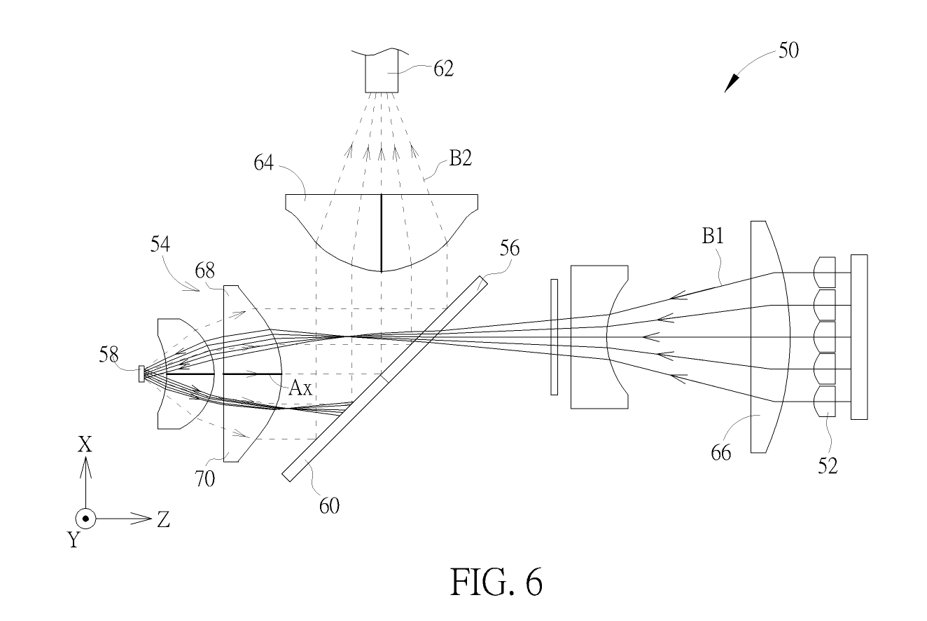

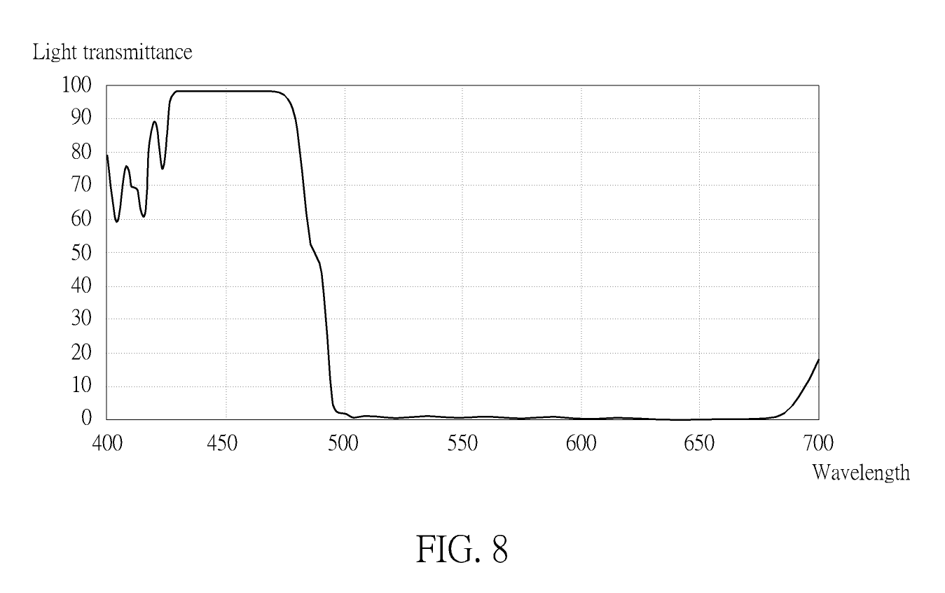

Please refer to FIG. 6 and FIG. 8. FIG. 6 is a diagram of the projector 50 according to another embodiment of the present invention. FIG. 8 is a diagram of showing relation between light transmittance and a wavelength of a dichroic component 56 according to the foresaid embodiment of the present invention. The projector 50 can include a light source module 52, a collimating lens 54, a dichroic component 56, a wavelength conversion module 58, a first reflecting component 60, a light guiding component 62, a first condenser lens 64 and a second condenser lens 66. The second condenser lens 66 can be disposed between the light source module 52 and the dichroic component 56. The wavelength conversion module 58 can be disposed on a side of the dichroic component 56 different from the light source module 52. The collimating lens 54 can be disposed between the dichroic component 56 and the wavelength conversion module 58. The collimating lens 54 can have a first part 68 and a second part 70; the dichroic component 56 corresponds to the first part 68, and the first reflecting component 60 is connected to the dichroic component 56 and corresponds to the second part 70. The light guiding component 62 and the wavelength conversion module 58 can be both disposed on the upper side or the left side of the dichroic component 56, which means −Z axis of the dichroic component 56. Alight receiving path and a light reflecting path of the wavelength conversion module 58 are not parallel to a light receiving path of the light guiding component 62. In addition, the dichroic component 56 of this embodiment can be passed by light in the specific wavelength range (such as the blue light), and can reflect light not in the specific wavelength range (such as the yellow light).

As shown in FIG. 6, the light source module 52 can provide the illumination beam Bl, and the illumination beam B1 can be converged by the second condenser lens 66 and project onto the dichroic component 56. The dichroic component 56 can be passed by the illumination beam B1 (such as the blue light) and reflect the excitation beam B2 (such as the yellow light), as the optical property shown in FIG. 8. The illumination beam B1 can sequentially pass through the dichroic component 56 and the first part 68 of the collimating lens 54 to the wavelength conversion module 58. Apart of the wavelength conversion module 58 can reflect the illumination beam B1 to pass through the second part 70 of the collimating lens 54 for projecting onto the first reflecting component 60, and the other part of the wavelength conversion module 58 can generate the excitation beam B2 to pass through the collimating lens 54 (including the first part 68 and the second part 70) for projecting onto the dichroic component 56 and the first reflecting component 60. The first reflecting component 60 can reflect the illumination beam B1 and the excitation beam B2, and the dichroic component 56 can reflect the excitation beam B2, so that the illumination beam B1 and the excitation beam B2 can be converged by the first condenser lens 64 to project onto the light guiding component 62.

In conclusion, the projector of the present invention utilizes the wavelength conversion module capable of reflecting the illumination beam and generating the excitation beam to match with the dichroic component corresponding to the first part of the collimating lens, to form the alignment module having a least amount of elements within constrained space for mixing. The dichroic component may have several applications; for instance, the dichroic component can reflect the illumination beam and allow passing of the excitation beam, or can allow passing of the illumination beam and reflect the excitation beam. Arrangement of the light source module, the dichroic component and the light guiding component of the projector may be changed in accordance with the dichroic component having specific features.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector, comprising:
a light source module configured to provide an illumination beam;
a collimating lens configured to receive and transmit the illumination beam, the collimating lens comprising a first part and a second part, and an axle positioned between the first part and the second part;
a wavelength conversion module configured to receive the illumination beam through the first part and accordingly generate an excitation beam toward the first part and the second part; and
a dichroic component disposed on a position corresponding to the first part, the dichroic component being configured to reflect the illumination beam to the first part and be passed through by the excitation beam, or the dichroic component being configured to be passed through by the illumination beam and reflect the excitation beam.

2. The projector of claim 1, wherein the axle is a central axle of the collimating lens.

3. The projector of claim 1, wherein when the dichroic component is configured to reflect the illumination beam to the first part and be passed through by the excitation beam, the projector further comprises:
a light penetrating component connected to the dichroic component and disposed on a position corresponding to the second part, the illumination beam and the excitation beam passing through the light penetrating component.

4. The projector of claim 3, further comprising:
a transparent substrate disposed on a position corresponding to the first part and the second part, the transparent substrate comprising a first area and a second area, the first area being covered by a coating to form the dichroic component, and the second area being the light penetrating component.

5. The projector of claim 3, wherein the light penetrating component has an optical diffusion property used to diffuse the illumination beam and the excitation beam.

6. The projector of claim 1, wherein when the dichroic component is configured to be passed through by the illumination beam and reflect the excitation beam, the projector further comprises:
a first reflecting component connected to the dichroic component and disposed on a position corresponding to the second part, the first reflecting component being used to reflect the illumination beam and the excitation beam.

7. The projector of claim 1, wherein the wavelength conversion module comprises a first region and a second region, the first region is used to reflect the illumination beam emitted from the first part to the second part, the second region has a wavelength conversion coating, the wavelength conversion coating is used to receive the illumination beam and generate the excitation beam.

8. The projector of claim 1, wherein the wavelength conversion coating contains phosphor powder or quantum dot material.

9. The projector of claim 1, wherein the wavelength conversion module is rotatable.

10. The projector of claim 1, further comprising:
a light guiding component configured to receive the excitation beam from the first part and the second part and the illumination beam from the second part.

11. The projector of claim 10, further comprising:
a first condenser lens disposed between the dichroic component and the light guiding component, and configured to converge the illumination beam and the excitation beam.

12. The projector of claim 1, wherein the light source is disposed on a position corresponding to the dichroic component.

13. The projector of claim 1, further comprising:
a second condenser lens disposed between the light source module and the dichroic component, and configured to converge the illumination beam projected onto the dichroic component.

14. The projector of claim 1, further comprising:
a light diffusing component disposed between the light source module and the dichroic component, and configured to diffuse the illumination beam.

15. The projector of claim 1, further comprising:
a second reflecting component configured to reflect the illumination beam toward the dichroic component.

16. The projector of claim 1, wherein the illumination beam is blue light, the dichroic component is used to reflect the blue light and be passed by other color light, or is used to be passed by the blue light and reflect other color light.

17. The projector of claim 1, wherein the excitation beam is yellow light.
